(19) United States
(12) Patent Application Publication
(10) Pub. No.: US 2010/0038903 A1
(43) Pub. Date: Feb. 18, 2010

(54) PIPE COUPLER AND COUPLING SYSTEM WITH POSITIVE RETENTION AND SEALING CAPABILITY

(76) Inventors: Thomas A. Linhorst, St. Louis, MO (US); Corey J. Hemman, St. Louis, MO (US); Michael Lurk, St. Louis, MO (US)

Correspondence Address: HAVERSTOCK ROBERTS LLP, 514 EARTH CITY EXPRESSWAY, SUITE 131, EARTH CITY, MO, 63045, US

(21) Appl. No.: 12/542,300

(22) Filed: Aug. 17, 2009

Related U.S. Application Data
(60) Provisional application No. 61/089,403, filed on Aug. 15, 2008.
(60) Provisional application No. 61/089,774, filed on Aug. 18, 2008.
(60) Provisional application No. 61/220,692, filed on Jun. 26, 2009.
(60) Provisional application No. 61/222,272, filed on Jul. 1, 2009.

(51) Int. Cl. F16L 19/00

(52) U.S. Cl. 285/365

(57) ABSTRACT

A coupler for joining a pipe to another pipe, a tee, or other fitting, which provides positive retention of a gasket about the circumference of the coupler sufficiently to precisely position and hold the gasket during placement about pipe ends and/or fittings to be coupled, and which provides controlled circumferential compression of the gasket during coupling, for positive sealing when the coupler is closed, and which provides a coupling system allowing one handed handling and operation during placement and coupling, such that the other hand can be used for supporting a pipe to be coupled, and which is operable for releasing and breaking loose the coupler and associated gasket from a pipe during uncoupling.

This application claims the benefit of U.S. Provisional Application No. 61/089,403, filed Aug. 15, 2008; 61/089,774, filed Aug. 18, 2008; and 61/220,692, filed on Jun. 26, 2009; and 61/222,272, filed on Jul. 1, 2009.

### TECHNICAL FIELD

This invention relates generally to a coupler for joining a pipe to another pipe, a tee, or other fitting, and more particularly, to a coupler which provides positive retention of the gasket about the circumference of the coupler sufficiently to precisely position and hold the gasket during placement about pipe ends and/or fittings to be coupled, and which provides controlled circumferential compression of the gasket during coupling, for positive sealing when the coupler is closed, and which provides a coupling system allowing one handed handling and operation during placement and coupling, such that the other hand can be used for supporting a pipe to be coupled, and which is operable for releasing and breaking loose the coupler and associated gasket from a pipe during uncoupling.

### BACKGROUND OF THE INVENTION

U.S. Provisional Application No. 61/089,403, filed Aug. 15, 2008; U.S. Provisional Application No. 61/089,774, filed Aug. 18, 2008; U.S. Provisional Application No. 61/220,692, filed on Jun. 26, 2009; and U.S. Provisional Application No. 61/222,272, filed on Jul. 1, 2009, are incorporated herein by reference in their entirety.

Pipe couplers are well known for use in coupling pipes in sealed relation to other pipes, tees and other fittings, to provide a continuous sealed passage for the flow of fluids, including both liquids and solids, such as, but not limited to, chemicals, food products, and particulates such as cement. Such couplers are commonly used in piping systems on bulk materials transports and hoppers, for conveying fluid carried thereby. Desirable feature of such couplers include the ability to quick and easy couple and uncouple, to enable disassembly of pipes or removal of pipes from tees and the like, for purposes such as inspection, cleaning and repair. For instance, after travel to a delivery site and unloading, it may be required to uncouple the pipes of a transport or hopper for cleaning and preparing for transporting a different material. Or, it may be found that a pipe has become clogged, so as to require uncoupling for removal of the clog. Or a coupler gasket may be damaged or otherwise leaking, so as to require replacement.

Reference, Sisk U.S. Pat. Nos. 5,540,465 and 5,722,666, and U.S. Patent Publication No. 2005/0248098; Burian et al., U.S. Pat. No. 7,165,789; and Heelan et al. U.S. Patent Publication No. 2008/0136167, which disclose a variety of known hinged pipe couplers or clamp assemblies, and gaskets, some of which gaskets are annular, and some of which are semi-circular.

Problems commonly encountered when coupling pipes and fittings on bulk transports and hoppers, include that the coupler gasket can be improperly seated in the coupler as the pipes or fittings are being coupled. The pipes can be heavy, particularly when filled or partially filled with material, and thus can be hard to handle and position for coupling by one person, which can contribute to this problem. This can be particularly problematic with some couplers that require the bail of the coupler to be disconnected from the opposite side of the coupler to open the coupler sufficiently to place it on the pipe ends to be coupled, e.g., Sisk et al. and Heelan et al. patents and publications, or wherein the bail can remain connected, but can inadvertently disconnect, e.g., Burian et al. patent.

Further in the above regard, some couplers, such as that disclosed in U.S. Pat. No. 7,165,789, are designed for use with a split gasket which is positively retained by the coupler only at the ends. As a result, during coupling, as the ends of the coupler and gasket are brought together, the gasket is pulled or drawn about the ends of the pipes or pipe and fitting being coupled, to bring the split gasket ends together in sealed relation. If the gasket drags or sticks as it is pulled about the pipe ends, sealing pressure about the circumference of the coupler may be uneven. The desired sealed condition at the joint between the ends of the gasket also may not be completely or uniformly compressed or formed, so as to leak.

As another problem, when uncoupling a coupler, the gasket can stick to the pipe, and/or the coupler can stick to the gasket, making removal difficult, and if force is applied, for instance, using a hammer or mallet to open the coupler, the gasket can be torn or otherwise damaged. And, if a split gasket is unavailable and instead it is attempted to use an annular gasket, the cavities are sufficiently large, particularly in sideward extent, such that annular gasket can deform into the cavities so as to leak.

Further, if the clamping mechanism of many of the known couplers is improperly adjusted, more force than normally necessary may be needed to close the coupler. Rather than properly adjust the coupler, some personnel will attempt to force the coupler closed, for instance by striking it, or using additional leverage on the handle of the clamping mechanism, e.g., by extending the length using an extender or cheater bar. This can damage the clamp, e.g., break the handle of the mechanism. And similarly, if the coupler clamping mechanism is stuck closed, some persons will attempt to pry it open by using additional leverage. This can also damage the coupler or clamping mechanism.

Regarding adjusting the clamping mechanism, some couplers, such as those of the Sisk et al. patent and publication identified above, require adjusting nuts on opposite ends of a U-shaped bail assembly, which can be time consuming and discouraging to personnel to adjust. Others, such as the Burian et al. and Heelan et al. couplers, use a single bail, but the adjusting nut is located so as to be very difficult to access, which also discourages adjustment. As a result, it has been found that many of the known couplers in use in the field are improperly adjusted, so as to be susceptible to leakage and damage.

Still further, some of the known couplers have handles that are susceptible to pinching a user's hand when closed, due to close proximity of the handle to the coupler body.

Accordingly, what is sought is a pipe coupler providing a one-handed operability that overcomes one or more of the problems and shortcomings set forth above.

### SUMMARY OF THE INVENTION

What is disclosed is a pipe coupler apparatus and system providing a one-handed operability that overcomes one or more of the problems set forth above.

According to a preferred aspect of the invention, the coupler of the apparatus and system comprises a pair of generally semi-circular or clam shell elements. Each semi-circular element has a generally C-shaped profile and is configured for receiving and holding a corresponding portion of a gasket, in the conventional manner. The semi-circular elements have first end portions hingedly connected together, and second end portions securely connected together by a clamping mechanism configured to remain connected even when the second ends of the elements are spread apart when the coupler is open. As a result, the coupler in the open configuration can be placed on a pipe end (without requiring sliding the gasket thereover as with an annular gasket), and held in place with just one hand without risk of the clamping mechanism coming apart, to allow the other hand to be used for handling the other pipe for positioning it for coupling. When the pipes are positioned for coupling, the clamping mechanism of the coupler can then be positioned about both pipe ends (again without sliding the gasket) and operated to clamp the coupler with just one hand, to couple the pipes together.

According to another preferred aspect of the invention, the clamping mechanism includes a handle pivotally connected with one of the semi-circular elements and to one end of a bail rod. The opposite end of the bail rod pivotably connects to the other semi-circular element. Each end of the bail rod is fixed or secured, at its pivotal connection to the handle or the other of the semi-circular elements, respectively, such that the bail rod can be pushed longitudinally, not just pulled as required for clamping. This is an advantageous feature, as it enables a manual force to be applied to the handle in the direction for unclamping the coupler, for also opening the coupler and releasing or breaking the coupler away from a pipe of fitting. This is desirable, as it can eliminate need for striking the coupler with a hammer or the like to release it, and the possible damage that result.

As another preferred aspect of the invention, the coupler is configured so as to be usable with a split or annular gasket. In this regard, the semi-circular elements of the coupler are configured for cooperatively receiving and holding either a split gasket, which can be of a one piece design split at just one location, or a multiple piece design, such as, but not limited to, a two-piece design of semi-circular pieces. For use with a split gasket, the semi-circular elements of the coupler include elements configured for holding or retaining the gasket on or in connection with the element, preferably comprising at least one cavity in an inner circumferential surface of the semi-circular element, configured for cooperatively receiving and holding a mating projection on the gasket for holding or retaining the gasket on the element. Also preferably, this feature is located on each of the second ends of the semi-circular elements, near the clamping mechanism, and on the free ends of the gasket, so as to advantageously allow the rest or body of the gasket to slide or move along the inner circumferences of the semi-circular elements as the semi-circular elements are closed or brought together about the ends of two pipes or a pipe and a fitting for coupling, to avoid bunching of the gasket which can interfere with or prevent closure of the coupler. Each cavity is sufficiently large such that the projection is robust enough for holding the gasket at that location, and to allow pulling the gasket as the coupler is closed, but is at the same time is sufficiently small, at least in sideward extent, that is, across the gasket, such that if an annular gasket or one without the projections is used instead, the annular gasket will largely span the cavity and not enter it so as to deform and result in a leak. Preferably here, the projection and cavity have a dovetail shape.

As still another preferred aspect of the invention, the bail rod of the clamping mechanism is configured so as to be adjustable in effective length between the points of attachment to the handle and the other semi-circular element, to enable easily and precisely adjusting operation of the clamping mechanism and the tension in the bail rod when clamped. Here, the term “effective length” denotes that portion of the length of the bail rod extending between the pivot points on the handle and on the other of the semi-circular elements. Preferably in this regard, a clevis is provided on the other of the semi-circular elements, which supports a pivot pin in a spacer or sleeve. The pivot pin and the spacer have aligned through holes which receive an end of the bail rod, and hold it centered in the clevis. This connection also includes a longitudinal adjusting mechanism for adjusting the effective length of the bail rod, preferably comprising a threaded portion secured by an adjusting nut. The pivot pin and the spacer are preferably positioned within the clevis such that the adjusting nut is sufficiently accessible to be engageable by a standard tool such as a socket, box end or open end wrench, for threaded rotation about the threaded end of the bail rod, including with the handle positioned for applying just initial tension on the bail rod, for increasing or decreasing the effective length of the bail rod. A second nut or other retainer is provided on the opposite side of the pivot pin and spacer, and is positionable thereagainst to prevent movement of the bail rod longitudinally relative to the pivot pin and spacer.

As still another preferred feature of the invention, at least one pivotal connection of the clamping mechanism is releasable, to allow the coupler to be opened by a greater extent, to facilitate use with an annular gasket, and also other purposes, such as for disassembly and cleaning. Here, a preferred configuration utilizes a removable pin for pivotal connection of the bail rod to the handle, which pin can be held in place by a conventional detent, such as an E-clip or the like that is repeatedly removable. As another feature, this end of the bail rod is preferably configured having a rectangular sectional shape which is received in the clevis of the handle, to provide added strength, particularly laterally, and ease and economy of manufacture.

As further preferred features of the invention, the handle has a generally C-shape when viewed from the side, including large radius edges for improved ergonomics, and such that the free end of the handle curves back toward the coupler, to provide an opening sufficiently large for receiving a gloved hand, and for reducing locations where a person's hand can be pinched against the outer side of the coupler. This shape also makes it difficult to use leverage increasing tools on the handle for closing the coupler, which can damage or break the handle or other components of the coupler. And, to further strengthen the handle, and its pivotal attachment to the semi-circular element, the handle end and the semi-circular element both include clevises, essentially forming a clevis in a clevis for strength against lateral loads.

### BRIEF DESCRIPTION OF THE DRAWINGS

FIG. 1 is a simplified side view of a pipe coupler constructed and operable according to the teachings of the invention;

FIG. 2 is a perspective view of the pipe coupler of FIG. 1;

FIG. 3 is an end view of the coupler;

FIG. 4 is another end view of the coupler;

FIG. 5 is a sectional view of the coupler;

FIG. 6 is another end view of the coupler;

FIG. 7 is an exploded view of the coupler;

FIG. 8 is another sectional view of the coupler;

FIG. 9 is a side view of the coupler in an open configuration about a pipe, and illustrating application of a force against a handle of the coupler;

FIG. 10 is a fragmentary perspective view of a semi-circular element of the coupler, showing a feature for retaining a gasket;

FIG. 11 is a fragmentary end view of the semi-circular element of FIG. 10, showing the gasket in dotted lines;

FIG. 11A is another fragmentary end view of the semi-circular element of FIG. 10, showing use of an annular gasket therein, and pipes coupled together by the coupler without leakage;

FIG. 12 is a perspective view showing two of the couplers of the invention in association with a pair of hopper tees and a pipe to be coupled thereto using the couplers;

FIG. 13 is another perspective view, showing one of the couplers closed for coupling the pipe to one of the tees, and another of the couplers opened and positioned for coupling the pipe to the other of the tees;

FIG. 14 is a side view of the coupler and illustrating a hand grasping the handle thereof;

FIG. 15 is a sectional view of a prior art pipe coupler coupling two pipes together, illustrating a leakage problem that can be encountered when using the coupler with an annular gasket;

FIG. 16 is a simplified sectional view of the pipes and coupler of FIG. 15, illustrating the leakage using arrows;

FIG. 17 is a side view of the coupler of the invention including an alternative bail rod construction;

FIG. 18 is a fragmentary sectional view though the coupler showing the alternative bail rod;

FIG. 19 is another fragmentary sectional view though the coupler showing the end of the alternative bail rod; and

FIG. 20 is another fragmentary sectional view of the coupler.

### DETAILED DESCRIPTION OF THE INVENTION

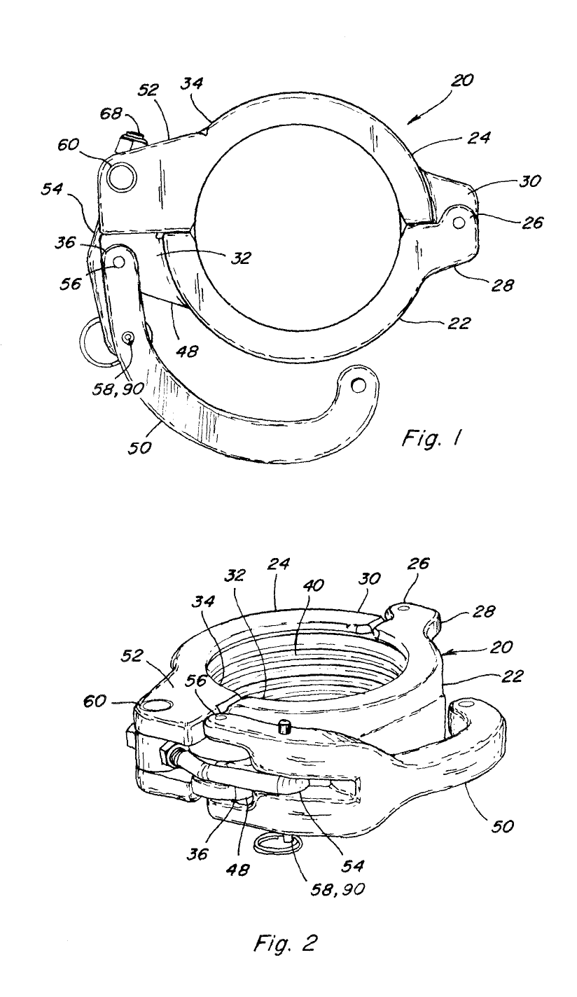

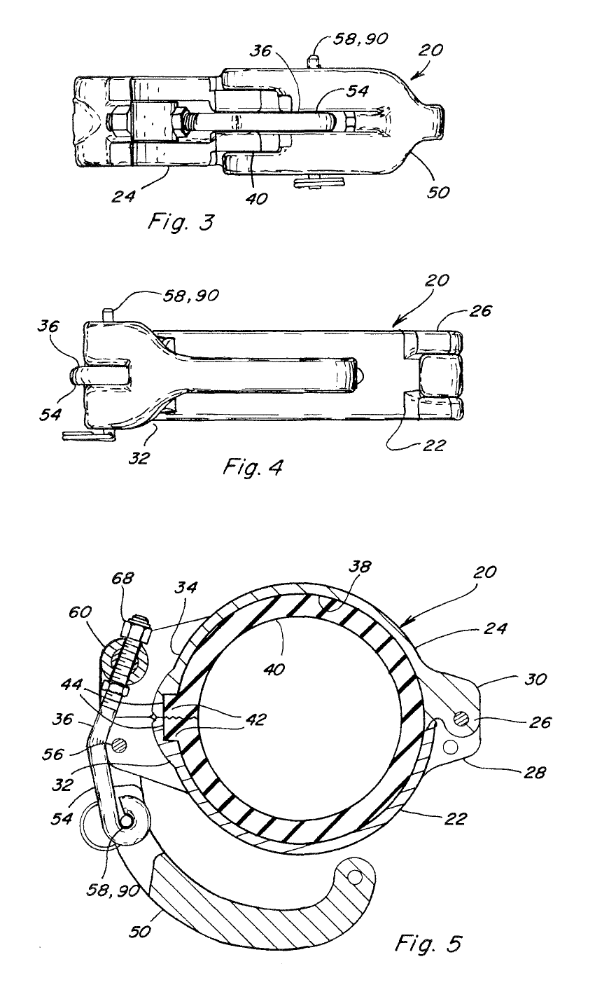

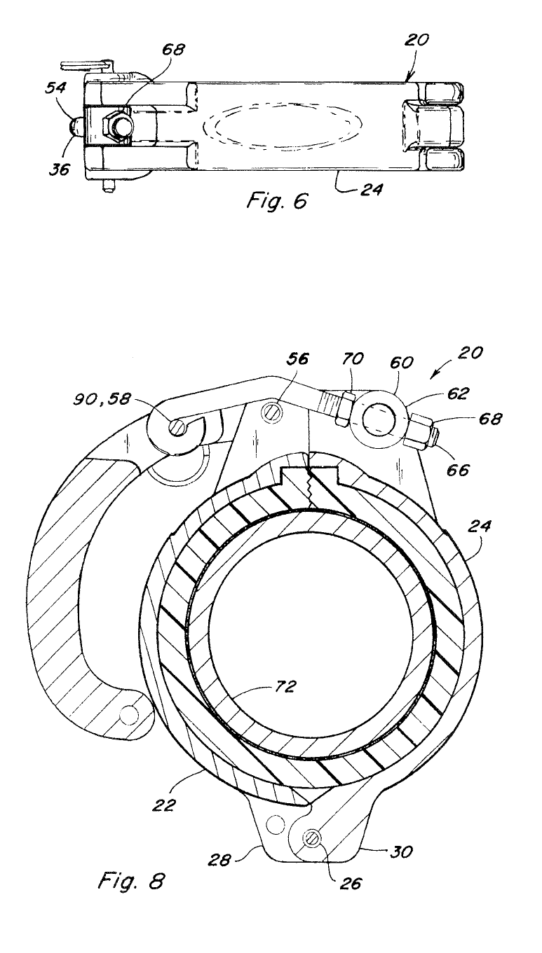

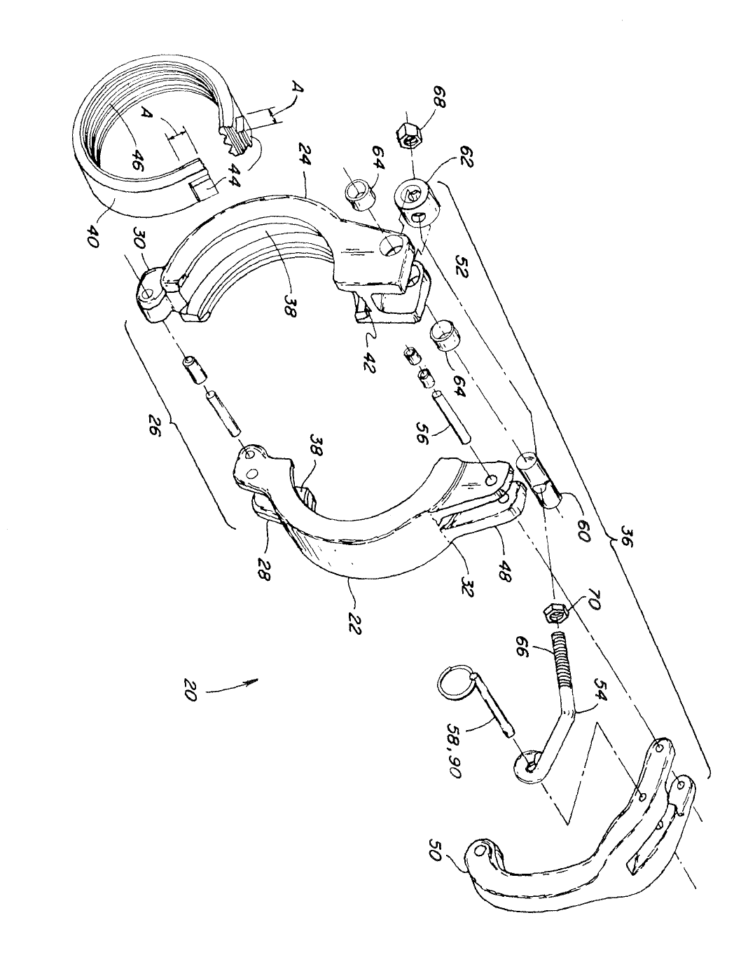

Referring to FIGS. 1 through 11A, a pipe coupler 20 constructed and operable according to the teachings of the present invention, is shown. Coupler 20 includes a first semi-circular element 22, and a second semi-circular element 24, having first end portions 28 and 30, respectively, connected for relative hinged movement by a hinge joint 26. Elements 22 and 24 include second end portions 32 and 34, which are brought together when the elements are hingedly closed, and include elements of a clamping mechanism 36 operable, including with just one hand, for securing the coupler about pipe ends, or a pipe end and a fitting, to be coupled together.

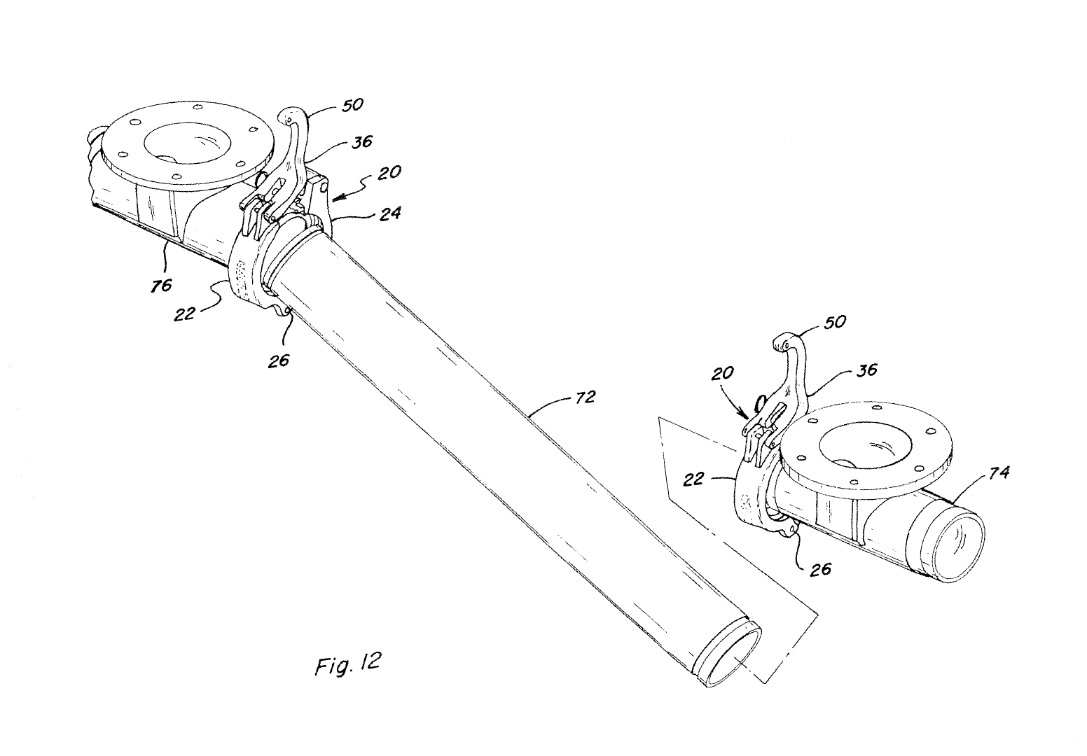

Each of semi-circular elements 22 and 24 as a generally C-shaped cross-sectional shape defining a channel 38 adapted for receiving a gasket 40, which here is a one-piece, split type gasket. Second end portions 32 and 34 of elements 22 and 24 each additionally include a cavity 42, which is open in the radial inward direction and toward the end of the semi-circular element, and which has a dovetail shape when viewed from the end. Gasket 40 includes a pair of correspondingly or matingly dovetail shaped projections 44, configured to be cooperatively received within cavities 42, respectively, for retaining gasket 40 in connection with end portions 32 and 34. Here, it should be noted that cavities 42 and projections 44 have a maximum sideward extent denoted by the distance X (FIGS. 10 and 11), which is substantially less than the width of the adjacent portion of channel 38 denoted by the distance Y, such that the cavity is correspondingly substantially narrower than gasket 40 at that location. As a representative ratio of X:Y, a value of about 1.0:1.3 has been found to work well for a coupler of the type shown. Cavities 42 and projections 44 have a substantial length A (FIG. 7). This sizing provides sufficient robustness for retaining gasket 40 during closure of coupler 20, including in opposition to pulling of gasket 40 away from the end portion 32 or 34 as it is stretched about a pipe end. But importantly, the extent X is sufficiently narrow, e.g., 50% or less of extent Y, such that a gasket not including a projection 44, will not deform into cavity 42 so as to possibly leak. This is an advantage of coupler 20, as it allows usage of gaskets other than gasket 40, including annular gaskets, without danger of leakage at this location, as is possible with other known coupler designs. This capability is illustrated in FIG. 11A, using an annular gasket 80 not including projections 44. Gasket 40 is illustrated having a serrated inner surface 46 (FIG. 7) but other surface configurations can also be used. Gasket 40 is also illustrated as having a sufficient length so as to project a marginal distance beyond end portions 32 and 34 of semi-circular elements 22 and 24, when coupler 20 is open, so as to be compressed together when the coupler is closed for forming a sealed condition. The opposing ends of gasket 40 can be serrated as shown. Here, it should be noted that channels 38 of semicircular elements 22 and 24 are shaped and sized for receiving a variety of conventional gaskets, including commercially available annular gaskets, and the configuration of cavities 42 are advantageous for preventing leakage due to deformation of the gasket into the cavity when no projections 44 are present.

Second end portion 32 of semi-circular element 22 includes a clevis 48 configured for pivotal connection with a handle 50 of clamping mechanism 36, which provides robustness for resisting lateral forces. Similarly, second end portion 34 of element 24 includes a clevis 52 configured for pivotal connection with a bail rod 54 of mechanism 36, which also provides robustness.

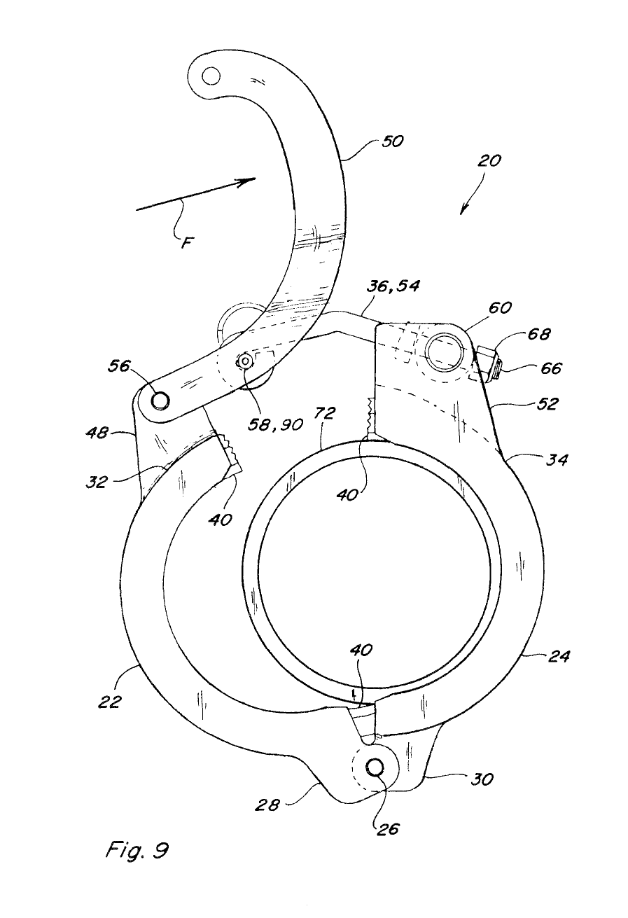

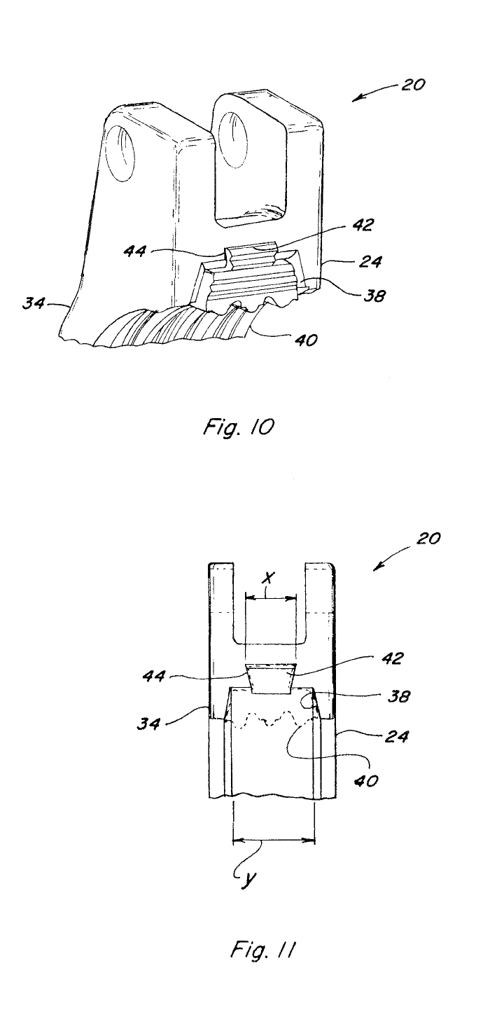

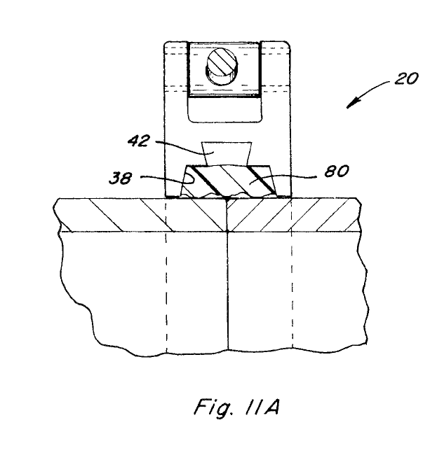

Clamping mechanism 36 is configured to connect second end portions 32 and 34 of semi-circular elements 22 and 24, so as not to come apart under normal circumstances. To achieve this, handle 50 is connected by a pivotal connection 56 to clevis 48; one end of bail rod 54 is connected by a pivotal connection 58 to handle 50; and the opposite end of rod 54 is connected by a pivotal connection 60 to clevis 52. These connections are configured to not come apart under normal operating conditions. But connection 58 utilizes a removable pin 90 to allow the mechanism to be intentionally separated. Pin 90 can be retained using any suitable detent, such as, but not limited to, a well-known E-clip. An advantage of this capability is that coupler 20 can be hung over a pipe end without danger of inadvertent disconnection, which allows a person to handle a mating pipe with both of his or her hands, and then to close coupler 20 using only a single hand, allowing the other hand to be used for supporting one of the pipe ends. Another advantage is that a hand force can be exerted against handle 50, as denoted by force arrow F in FIG. 9 for releasing or breaking coupler 20 from a pipe, such as pipe 72 illustrated. This is advantageous, as noted above, as it eliminates need for using a tool, such as a bar, hammer, mallet or the like, for this purpose, which can damage the coupler or gasket.

Bail rod 54 of clamping mechanism 36 is configured so as to be adjustable in effective length between the points of pivotal attachment to handle 50 and second semi-circular element 24, to enable easily and precisely adjusting operation of the clamping mechanism and the tension in the bail rod when clamped. Here, the term “effective length” more particularly denotes that portion of the length of bail rod 54 extending between pivotal connections 58 and 60 on handle 50 and clevis 52. In this regard, pivotal connection 60 comprises a spacer 62 with bushings 64 on either end, which support a pin of connection 60 so as to be centered within clevis 52, a threaded end 66 of rod 54 extending through holes through spacer 62 and pin of connection 60. An adjusting nut 68 is threadedly engaged on threaded end 66 and can be threadedly loosened or tightened thereon, to adjust the effective length. Another nut 70 is also provided on the opposite side of spacer 62, to snug the rod against the spacer to prevent longitudinal slippage thereof. Here, it should be noted that pivotal connection 60 is preferably positioned within clevis 52 such that adjusting nut 68 is sufficiently accessible to be engageable by a standard tool such as a socket, box end or open end wrench, for threaded rotation about threaded end 66 of bail rod 54, including with handle 50 positioned for applying just initial tension on the bail rod, for increasing or decreasing the effective length of the bail rod.

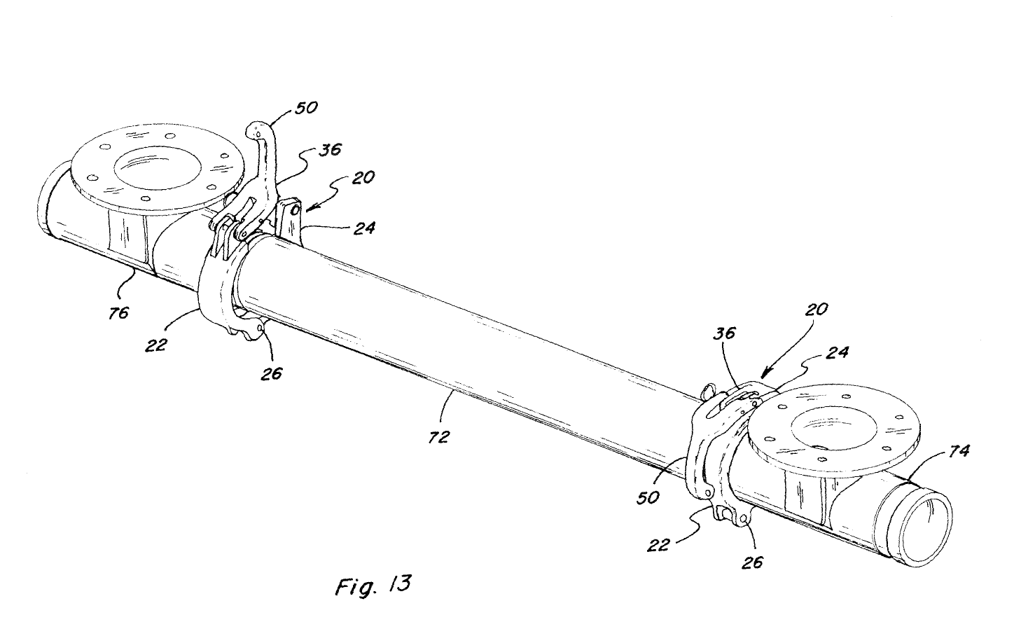

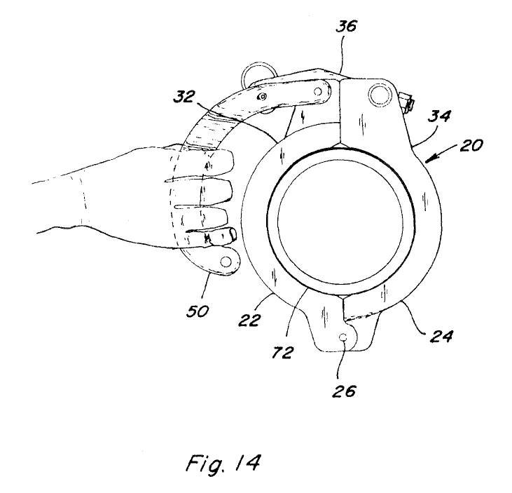

In FIGS. 12 and 13, two couplers 20 are illustrated for connecting a pipe 72 to a pair of spaced apart tees 74 and 76 for illustrating one handed operability of the system of the invention. This is intended to be representative of tees commonly found on the lower regions of bulk material transports and the like. Here, it can be observed that the right-hand coupler 20 can be placed on the pipe end of tee 74 and left there without danger of falling, as coupler 20 will not inadvertently come apart. The left-hand coupler 20, can be placed onto a pipe end of tee 76, such that one end of pipe 72 can be laid on that coupler 20. The opposite end of pipe 72 can then be brought into alignment with the pipe end of tee 74, and that coupler moved into position over both opposing pipe ends. The right-hand coupler 20 can then be closed using just one hand on handle 50, to couple those pipe ends. The handle 50 of the left-hand coupler can then be closed to couple that coupler to complete the connection. Here, it should be emphasized that each of couplers 20 can be closed using only one hand, while the other hand is free to hold one of the pipes to be joined together. It should also be noted that as a result of the use of a split gasket, the gasket does not have to be manually fitted over the pipe ends separately of the coupler, as is required when using annular gaskets.

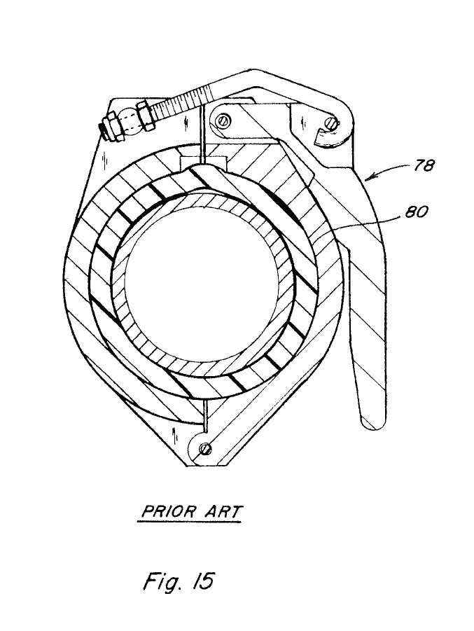

As illustrated in FIG. 14, handle 50 has a generally C-shape when viewed from the side, including large radius edges for improved ergonomics, and such that the free end of handle 50 curves back toward the coupler, to provide an opening sufficiently large for receiving a gloved hand, and for reducing locations where a person's hand can be pinched against the outer side of the coupler. This shape also makes it difficult to use leverage increasing tools on the handle for closing the coupler, which can damage or break the handle or other components of the coupler.

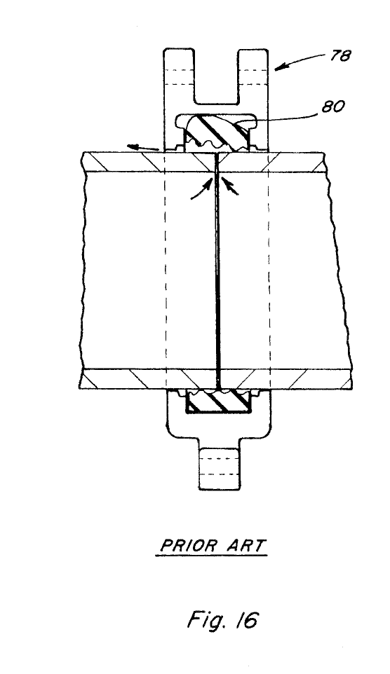

As illustrated in FIGS. 15 and 16, a prior art coupler 78 such as disclosed in U.S. Pat. No. 7,165,789, is shown. Coupler 78 has cavities as disclosed in that patent, for receiving projection of a split gasket. However, if a conventional annular gasket such as illustrated by gasket 80 is used, the gasket can deform into the cavities, so as to result in a leak of the material carried by the joined pipes, as illustrated by the small arrows. This problem will not be present when coupler 20 of the present invention is used with a conventional annular gasket, as cavities 42 are smaller and not large enough to allow this deformation, as discussed above. Additionally, because the bail rod of coupler 78 connects to the handle of that coupler with just a hook shaped end, any force applied thereto in a direction for opening the coupler would act to disconnect the handle from the bail rod instead.

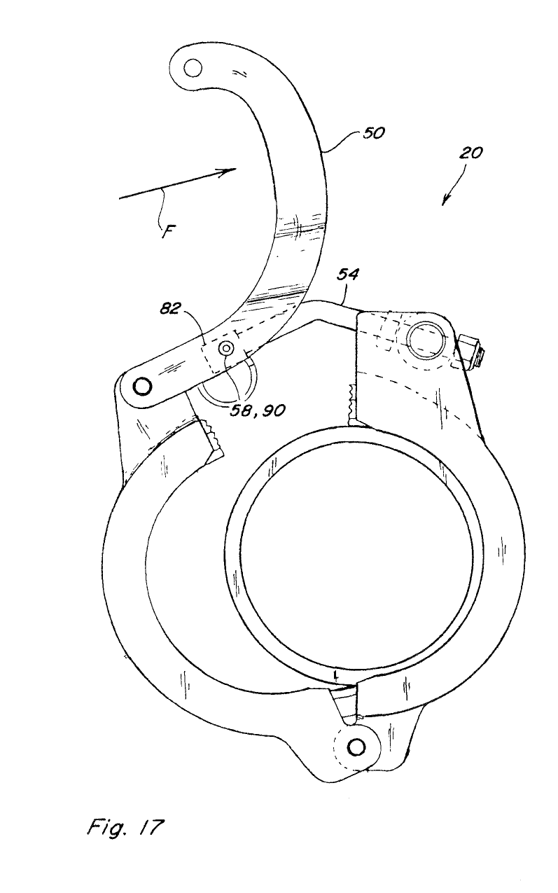

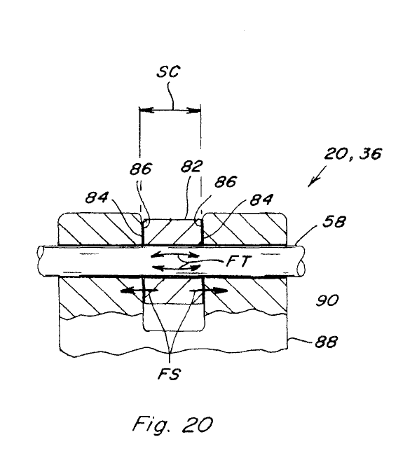

Referring to FIGS. 17, 18, 19 and 20, as an alternative bail rod construction for coupler 20, bail rod 54 can include an end 82 for connection to handle 50, generally rectangular cross sectional shape and having oppositely facing surfaces 84 disposed in surface to surface opposing, closely spaced relation to opposing, spaced apart surfaces 86 of a clevis 88 of handle 50. This configuration is advantageous to prevent torsional or twisting movements of bail rod 54 within the clevis and to provide robust strength and avoid stress concentrations resulting from loading conditions including tensile, compression, torsion, side and bending loads, anticipated to be encountered by the coupler during normal use. In particular, referring to FIG. 20, if a torsional force, such as denoted by arrows FT, and/or sideward force, denoted by arrows FS, is/are applied between a pin 90 of connection 58 and clevis 88 of the handle, sides 84 and 86 can be brought into surface to surface contact to distribute and transfer the forces over a greater area, to reduce occurrence of stress concentrations and other failure conditions that can otherwise result in breakage or bending of the bail rod end, and/or one or both sides of clevis 88.

Rectangular end 82 also extends sidewardly along and contacts substantially the entire length of pin 90 between spaced apart opposing surfaces 86 of clevis 88, that is, essentially the width between surfaces 86, as denoted by arrow SC in FIG. 20, such that more surface contact is maintained between that end of the bail rod and pin 90, compared to a bail rod end of circular cross section, such as of the coupler of FIGS. 1-14, and the prior art coupler of FIG. 15, wherein only a small portion of the circular cross sections of the pin and bail rod are in contact. As a non-limiting example, a rectangular end 82 having a longitudinal extent, denoted by distance LE in FIG. 19 in both direction beyond pin 90, which is about equal to or greater than a diametrical extent DP of pin 90, has been found to be adequate for withstanding anticipated side and torsional loading conditions.

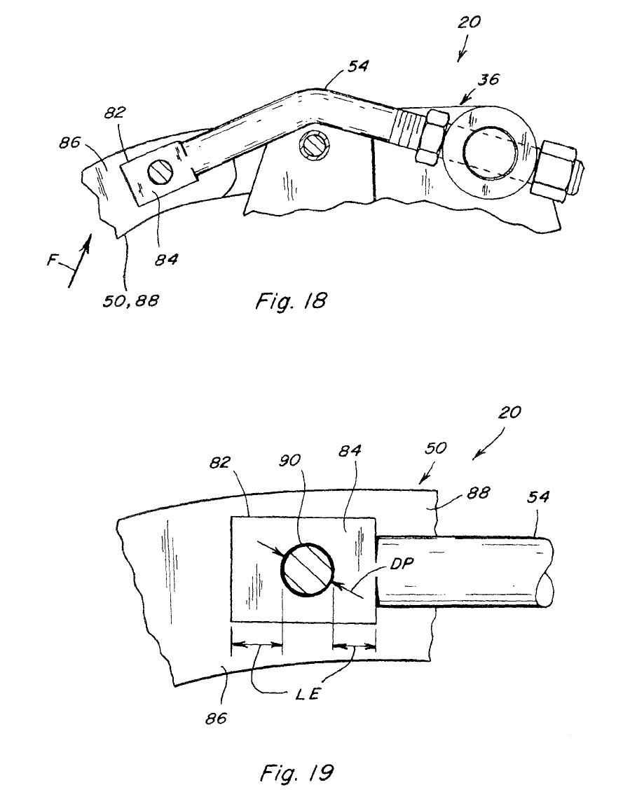

Additionally, whether using a bail rod including the end portion shown in FIGS. 17-20, or that of the previously illustrated embodiment of FIGS. 1-14, rectangular end 82 is configured to extend completely around pin 90 when viewed from the side, to enable the one-handed operation of the coupler for positioning about pipe or fitting ends to be coupled together as discussed above, and also to allow the application of a substantial force F against bail rod 54 for compressively loading it for opening clamp 20, and/or breaking it free from around coupled pipe and/or fitting ends, as illustrated in FIGS. 17 and 18. In this regard, the rectangular shape of end 82 is preferred, as it has been found to enable it to withstand substantial abuse when opening and breaking couplers loose from pipes. In contrast, as noted above, prior art coupler 78 as shown in FIG. 15 includes a bail rod having an end pivotally connected to the handle of that coupler which only partially surrounds the pinned connection, such that application of a substantial force in the above described manner to positively open or break loose the coupler from a pipe joint is not possible, as the end of the bail rod would simply detach from the pin. Further, because pin 90 of the present invention is also preferably easily removable to disconnect connection 58 and release handle 50 from clamping mechanism 36, to allow fully opening the coupler.

It will be understood that changes in the details, materials, steps, and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments, for instance having different diameter pipe sections, without departing from the scope of the invention. Accordingly, the following claims are intended to protect the invention broadly as well as in the specific form shown.

What is claimed is:

1. A pipe coupler adapted for coupling two pipe ends in abutting relation using one hand, comprising:
a first semi-circular clam shell element having a first end portion and an opposite second end portion;
a second semi-circular clam shell element having a first end portion and an opposite second end portion;
the first end portions of the clam shell elements being connected by a hinge joint for hinged relative movement;
each of the clam shell elements having a C-shaped cross sectional shape defining a radially inwardly open channel extending circumferentially therealong; and
a clamping mechanism connected to the second end portions of the clam shell elements, including a handle having one end pivotally connected to one of the second end portions, a bail rod having a first end pivotally connected to another of the second end portions and an opposite second end pivotally connected to the handle by a pivot joint at a location therealong intermediate the one end there and a free end thereof, the pivot joint including a pin extending through the second end of the bail rod and through a clevis on the handle, the clevis having opposing side surfaces defining a space therebetween which receives the second end of the bail rod, and said opposite end of the bail rod having a generally rectangular sectional shape extending completely about the pin and defined in part by oppositely facing surfaces disposed in closely spaced, opposing relation to the opposing surfaces of the clevis, in position for abutting in surface to surface relation when the handle and the clevis are relatively moved sidewardly.

2. The pipe coupler of claim 1, wherein the pin has a diametrical extent, and the rectangular sectional shape of the second end of the bail rod has a longitudinal extent at least about equal to the diametrical extent.

3. The pipe coupler of claim 1, further comprising a gasket located in the channels of the clam shell elements, extending about an inner circumferential periphery thereof, and the second end portion of each of the clam shell elements includes a radially outwardly extending cavity having a predetermined shape and matingly receiving projections extending radially outwardly from the gasket for retaining the gasket in the channels, respectively, each of the channels having a predetermined sideward extent and each of the cavities having a sideward extent substantially less than the sideward extent of the channels.

4. The pipe coupler of claim 3, wherein the cavities and projections have mating dovetail shapes, respectively.

5. The pipe coupler of claim 1, wherein the handle is C-shaped.

6. The pipe coupler of claim 1, wherein the first end of the bail rod comprises a threaded portion which passes through a pin pivotally connecting to said another of the second end portions, and threaded nuts on opposite sides of the pin threadedly engaged with the threaded portion, to allow adjusting a length of the bail rod extending between the handle and said another of the second end portions.

7. The pipe coupler of claim 6, wherein an endmost one of the nuts extends at least partially beyond said another of the second end portions.

8. A pipe coupler adapted for coupling two pipe ends in abutting relation using one hand, comprising, in combination:
a first semi-circular clam shell element having a first end portion and an opposite second end portion;
a second semi-circular clam shell element having a first end portion and an opposite second end portion;
the first end portions of the clam shell elements being connected by a hinge joint for hinged relative movement;
each of the clam shell elements having a C-shaped cross sectional shape defining a radially inwardly open channel extending circumferentially therealong and having a predetermined sideward extent, and the second end portion of each of the clam shell elements includes a radially outwardly extending cavity having a predetermined shape having a maximum sideward extent substantially less than the sideward extent of the channel; and
a clamping mechanism connected to the second end portions of the clam shell elements, including a handle having one end pivotally connected to one of the second end portions, a bail rod having a first end pivotally connected to another of the second end portions and an opposite second end pivotally connected to the handle by a pivot joint at a location therealong intermediate the one end there and a free end thereof, the pivotal connections of the bail rod to the handle and to said another of the second end portions being configured to allow exerting a compressive load longitudinally against the bail rod while remaining connected to the handle and to said another of the second end portions.

9. The pipe coupler of claim 8, further comprising a gasket located in the channels of the clam shell elements, extending about an inner circumferential periphery thereof, the gasket including projections matingly received in the cavities, retaining the gasket in the channels.

10. The pipe coupler of claim 9, wherein the cavities and projections have mating dovetail shapes, respectively.

11. The pipe coupler of claim 8, wherein the handle is C-shaped.

12. The pipe coupler of claim 8, wherein the first end of the bail rod comprises a threaded portion which passes through a pin pivotally connecting to said another of the second end portions, and threaded nuts on opposite sides of the pin threadedly engaged with the threaded portion, to allow adjusting a length of the bail rod extending between the handle and said another of the second end portions.

13. The pipe coupler of claim 12, wherein an endmost one of the nuts extends at least partially beyond said another of the second end portions.

14. A pipe coupler system for coupling two pipe ends in abutting relation using one hand, comprising, in combination:
a first semi-circular clam shell element having a first end portion and an opposite second end portion;
a second semi-circular clam shell element having a first end portion and an opposite second end portion;
the first end portions of the clam shell elements being connected by a hinge joint for hinged relative movement;
each of the clam shell elements having a C-shaped cross sectional shape defining a radially inwardly open channel extending circumferentially therealong;
a gasket located in the channels of the clam shell elements, extending about an inner circumferential periphery thereof; and
a clamping mechanism connecting the second end portions of the clam shell elements together, including a handle having one end pivotally connected to one of the second end portions, a bail rod having a first end pivotally connected to another of the second end portions and an opposite second end pivotally connected to the handle by a pivot joint at a location therealong intermediate the one end there and a free end thereof, such that the handle can be moved to bring the second end portions of the clam shell elements together, the pivotal connections of the bail rod to the handle and to said another of the second end portions being configured to prevent inadvertent disconnection thereof and to allow exerting a compressive load longitudinally against the bail rod while remaining connected to the handle and to said another of the second end portions.

15. The pipe coupler system of claim 14, wherein the second end portion of each of the clam shell elements includes a radially outwardly extending cavity having a predetermined shape and matingly receiving projections extending radially outwardly from the gasket for retaining the gasket in the channels, respectively, each of the channels having a predetermined sideward extent and each of the cavities having a sideward extent substantially less than the sideward extent of the channels respectively.

16. The pipe coupler system of claim 15, wherein the cavities and projections have mating dovetail shapes, respectively.

17. The pipe coupler system of claim 14, wherein the handle is C-shaped.

18. The pipe coupler system of claim 14, wherein the first end of the bail rod comprises a threaded portion which passes through a pin pivotally connecting to said another of the second end portions, and threaded nuts on opposite sides of the pin threadedly engaged with the threaded portion, to allow adjusting a length of the bail rod extending between the handle and said another of the second end portions.

19. The pipe coupler system of claim 18, wherein an endmost one of the nuts extends at least partially beyond said another of the second end portions.
